(19) United States
(12) Patent Application Publication
(10) Pub. No.: US 2026/0280815 A1
(43) Pub. Date: Sep. 17, 2026

(54) Methods And Apparatus For PDCCH Coverage Improvement In Mobile Communications

(71) Applicant: MediaTek Singapore Pte. Ltd., Singapore (SG)

(72) Inventors: Junqiang Cheng, Beijing (CN); Wen Tang, Beijing (CN); Tao Chen, Beijing (CN); Pei-Kai Liao, Hsinchu City (TW); Wei-De Wu, Hsinchu City (TW); Yi-Ju Liao, Hsinchu City (TW); Chenmeng Li, Beijing (CN)

(73) Assignee: MediaTek Singapore Pte. Ltd., Singapore (SG)

(21) Appl. No.: 19/564,136

(22) Filed: Mar. 11, 2026

(30) Foreign Application Priority Data
Mar. 14, 2025 (WO) PCT/CN2025/082643
Mar. 10, 2026 (CN) 2026102888000

(51) Int. Cl. H04L 5/00; H04W 72/23

(52) U.S. Cl. CPC H04L 5/0053; H04W 72/23

(57) ABSTRACT

Various solutions for improving physical downlink control channel (PDCCH) coverage are described. A network node may determine at least one of a maximum resource amount of a control resource set (CORESET) and CORESET repetitions for a PDCCH transmission, include parameters of the at least one of the maximum resource amount of the CORESET and the CORESET repetitions in a configuration, and transmit the configuration to the UE. The UE may receive the configuration and determine at least one of the maximum resource amount of the CORESET and the CORESET repetitions according to the configuration. The network node may perform the PDCCH transmission based on the configuration. The UE may determine a PDCCH according to at least one of the maximum resource amount of the CORESET and the CORESET repetitions and receive a downlink transmission on the PDCCH.

### CROSS REFERENCE TO RELATED PATENT APPLICATION(S)

The present disclosure is part of a non-provisional application claiming the priority benefits of PCT Application No. PCT/CN 2025/082643, filed on 14 Mar. 2025, and CN Application No. 202610288800.0, filed on 10 Mar. 2026, the content of which herein being incorporated by reference in their entirety.

### TECHNICAL FIELD

The present disclosure is generally related to mobile communications and, more particularly, to Physical Downlink Control Channel (PDCCH) coverage improvement with respect to apparatus in mobile communications.

### BACKGROUND

Unless otherwise indicated herein, approaches described in this section are not prior art to the claims listed below and are not admitted as prior art by inclusion in this section.

In mobile communications, robust control signaling coverage, especially when operating in higher frequency bands or when serving areas with challenging propagation conditions, such as Non-Terrestrial Networks (NTNs) or deep coverage scenarios is important. The PDCCH is critical, as it carries scheduling assignments and essential control information to user equipment (UE). However, at higher frequencies and in harsh environments, the PDCCH may suffer significant link budget deficiencies, making reliable decoding challenging. Consequently, there is a growing need for coverage improvement techniques that can maintain acceptable performance and quality of service.

Accordingly, proposing an appropriate PDCCH signal design for a new generation communication system has become a critical issue in wireless communication systems, and there is an urgent need to provide such procedures to ensure efficient and reliable operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to PDCCH coverage improvement with respect to apparatus in mobile communications.

In one aspect, a method may involve an apparatus receiving at least one configuration from a network node. The method may also involve the apparatus determining at least one of a maximum resource amount of a control resource set (CORESET) and CORESET repetitions according to the at least one configuration. The method may further involve the apparatus determining a PDCCH according to the at least one of the maximum resource amount of the CORESET and the CORESET repetitions. The method may further involve the apparatus receiving a downlink transmission on the PDCCH.

In one aspect, a method may involve an apparatus determining at least one of a maximum resource amount of a CORESET and CORESET repetitions for a PDCCH transmission. The method may also involve the apparatus including parameters of at least one of the maximum resource amount of the CORESET and the CORESET repetitions in at least one configuration. The method may further involve the apparatus transmitting the at least one configuration to a user equipment (UE). The method may further involve the apparatus performing the PDCCH transmission based on the at least one configuration.

In one aspect, an apparatus may comprise a transceiver which, during operation, wirelessly communicates with a network node. The apparatus may also comprise a processor communicatively coupled to the transceiver. The processor, during operation, may perform operations comprising receiving, via the transceiver, at least one configuration from a network node. The processor may also perform operations comprising determining at least one of a maximum resource amount of a CORESET and CORESET repetitions according to the at least one configuration. The processor may further perform operations comprising determining a PDCCH according to the at least one of the maximum resource amount of the CORESET and the CORESET repetitions. The processor may further perform operations comprising receiving, via the transceiver, a downlink transmission on the PDCCH.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios 100 under schemes in accordance with implementations of the present disclosure.

FIG. 2 is a diagram depicting an example scenario 200 under schemes in accordance with implementations of the present disclosure.

FIG. 3 is a diagram depicting an example scenario 300 under schemes in accordance with implementations of the present disclosure.

FIG. 4 is a diagram depicting an example scenario 400 under schemes in accordance with implementations of the present disclosure.

FIG. 5A is a diagram depicting an example scenario 500a under schemes in accordance with implementations of the present disclosure.

FIG. 5B is a diagram depicting an example scenario 500b under schemes in accordance with implementations of the present disclosure.

FIG. 6A is a diagram depicting an example scenario 600a under schemes in accordance with implementations of the present disclosure.

FIG. 6B is a diagram depicting an example scenario 600b under schemes in accordance with implementations of the present disclosure.

FIG. 7 is a diagram depicting an example scenario 700 under schemes in accordance with implementations of the present disclosure.

FIG. 8 is a block diagram of an example communication system 800 in accordance with an implementation of the present disclosure.

FIG. 9 is a flowchart of an example process 900 in accordance with an implementation of the present disclosure.

FIG. 10 is a flowchart of an example process 1000 in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PDCCH coverage improvement in mobile communications. According to the present disclosure, a number of possible solutions may be implemented separately or jointly. That is, although these possible solutions may be described below separately, two or more of these possible solutions may be implemented in one combination or another.

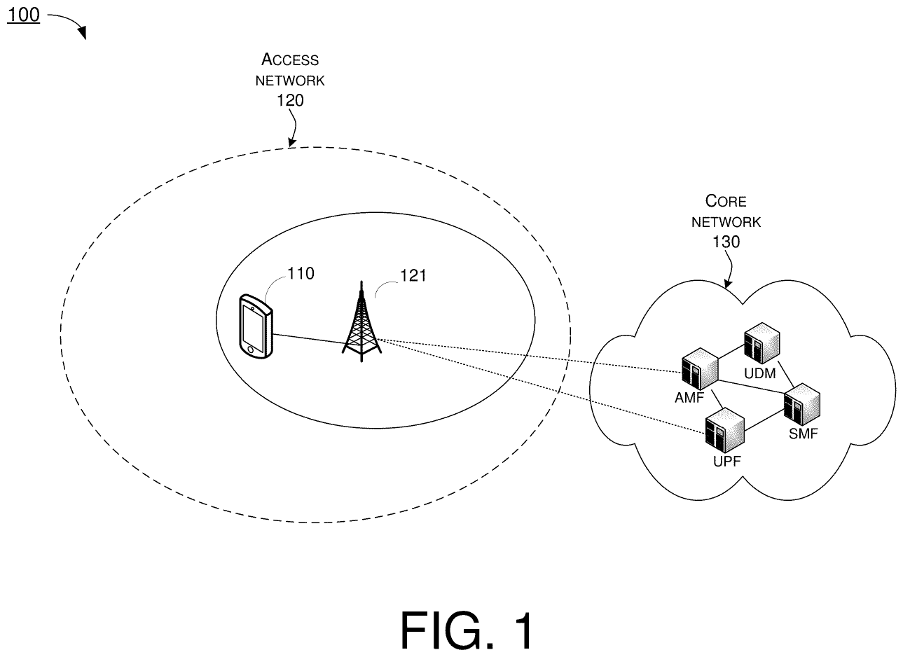

FIG. 1 illustrates an example scenario 100 of a communication environment in which various solutions and schemes in accordance with the present disclosure may be implemented. Scenario 100 involves a user equipment (UE) 110 in wireless communication with a wireless network (e.g., an LTE network, a 5G/NR network, an IoT network, or a 6G network, etc.) consisting of an access network 120 and a core network 130. The UE 110 may be a smartphone, a wearable device, an IoT device, or a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface. The access network 120 may include a network node 121, which may provide communication coverage for a geographic coverage area where communications with the UE 110 are supported. The network node may be called a base station (BS) or a cell. The core network may include entities, such as an access and mobility management function (AMF), a session management function (SMF), a unified data management (UDM), and a user plane function (UPF), etc. For illustrative purposes, one network node (i.e., network node 121) and one UE (UE 110) may be described hereinafter. However, it is not intended to limit the network scenarios of the present disclosure.

Several techniques are proposed to enhance PDCCH coverage. Among them, employing a lower coding rate and/or applying repetition (spanning time, frequency, or both) have shown promise in increasing signal reliability under poor channel conditions. However, incorporating these methods into a system design requires careful consideration of resource allocation (e.g., the design of control channel element (CCE), resource element group (REG), REG bundle, control resource set (CORESET), etc.), overhead, and complexity. The following invention addresses the challenge of strengthening PDCCH coverage by reducing coding rate, and/or flexible repetition strategies across time-domain and/or frequency-domain resources.

Various aspects of the present disclosure relate to the solutions on coverage improvement for a wireless channel/signal (e.g., PDCCH) are disclosed. In general, a method of reducing the coding rate may be proposed to improve the PDCCH coverage. These solutions may be achieved with a payload size decrement, and/or occupied resource increment for a CORESET. Additionally, a method of repetition is also proposed to improve the PDCCH coverage. The method of repetition may be achieved via PDCCH, CORESET, and/or search space set repetition in the time domain and/or the frequency domain.

In one embodiment, the network node may determine at least one of a maximum resource amount of a CORESET (e.g., occupied resource increment for a CORESET) and CORESET repetitions (for improving the PDCCH coverage) for a PDCCH transmission, include parameters of at least one of the maximum resource amount of the CORESET and the CORESET repetitions in at least one configuration (e.g., radio resource control (RRC) configuration), and transmit the at least one configuration to the UE. In one example, the network node may determine the maximum resource amount of the CORESET for the PDCCH transmission and include the parameters of the maximum resource amount in the configuration(s). In one example, the network node may determine the CORESET repetitions for the PDCCH transmission and include the parameters of the CORESET repetitions in the configuration(s). In one example, the network node may determine the maximum resource amount of the CORESET and the CORESET repetitions for the PDCCH transmission and include the parameters of the maximum resource amount and the CORESET repetitions in the configuration(s). In one example, the network node may determine the CORESET repetitions for the PDCCH transmission, e.g., CORESET0 or paging repetition, and include the parameters of the CORESET repetitions in the synchronization signal block (SSB) transmission, e.g., SSB repetition number or pattern. Then the UE may receive the at least one configuration and determine at least one of the maximum resource amount of the CORESET and the CORESET repetitions according to the at least one configuration. Accordingly, the network node may perform the PDCCH transmission based on the at least one configuration. The UE may determine a PDCCH according to at least one of the maximum resource amount of the CORESET and the CORESET repetitions and receive a downlink transmission on the PDCCH.

In the present disclosure, for improving the coverage of a wireless channel/signal, e.g., PDCCH, a lower coding rate R may be implemented. The coding rate R may be impacted by several factors including payload size N of the PDCCH, cyclic redundancy check (CRC) length L of the PDCCH, occupied resource amount (e.g., resource element (RE) number M), and modulation order Q. The coding rate R may be expressed as R−(N+L)/(M*Q). In one implementation, the payload size of PDCCH may be reduced to achieve a lower coding rate. In one embodiment, the payload of a PDCCH may be divided into several parts based on a set of thresholds. The methods for dividing a PDCCH payload into several parts may be disclosed. In one example, the PDCCH payload may be divided into two parts based on a threshold, where the 1^{st} part may be guaranteed with a payload size does not exceed the threshold. In one example, one threshold may be configured to divide the PDCCH payload into several parts (two or more), where each part may be guaranteed to have a payload size that does not exceed the threshold. The threshold may be pre-defined as a value of the largest payload size among a set of legacy NR downlink control information (DCI) formats.

In one embodiment, to reduce the code rate, a cyclic redundancy check (CRC) length shorter than 24 bits may be implemented for the PDCCH, e.g., 16 bits. In one example, a threshold may be used for determining the CRC length. In one example, for a PDCCH with a payload size shorter than the threshold, a CRC with a length shorter than 24 bits, e.g., 16 bits, may be used; Otherwise, a CRC with a length of 24 bits may be used.

In one embodiment, for reducing the code rate, a method of increasing the occupied or available resource amount (e.g., increasing occupied resource element (RE) number M of a PDCCH and/or CORESET) is disclosed. Generally, the RE number M may be increased via the CORESET extension in the time domain and/or frequency domain. Specifically, for the case of increasing RE number M via CORESET extension in the time domain, two mapping types between CCE and REG (CCE-REG-MappingType) are disclosed (i.e., interleaved and non-interleaved).

In one embodiment, for the CCE-REG-MappingType of interleaved, one method to increase the RE number M in the time domain is to enlarge the max CORESET duration (in the unit of Orthogonal Frequency Division Multiplexing (OFDM) symbol). In one example, a value of RRC parameter of maxCoReSetDuration in NR system may be increased. The candidate CORESET durations may be one or multiple values from the range of [1, maxCoReSetDuration]. In one example, the maxCoReSetDuration may be 4. The candidate CORESET durations may be {1, 2, 3, 4} symbols, or {1, 2, 4} symbols. In another example, the max CoReSetDuration may be 6. The candidate CORESET durations may be {1, 2, 3, 6}. At the same time, the number of REGs making up a CCE should be the least common multiple of all candidate CORESET durations. Additionally, a REG bundle may comprise multiple REGs. A REG may comprise one RB during one OFDM symbol, or multiple RE(s), e.g., 6, during one OFDM symbol.

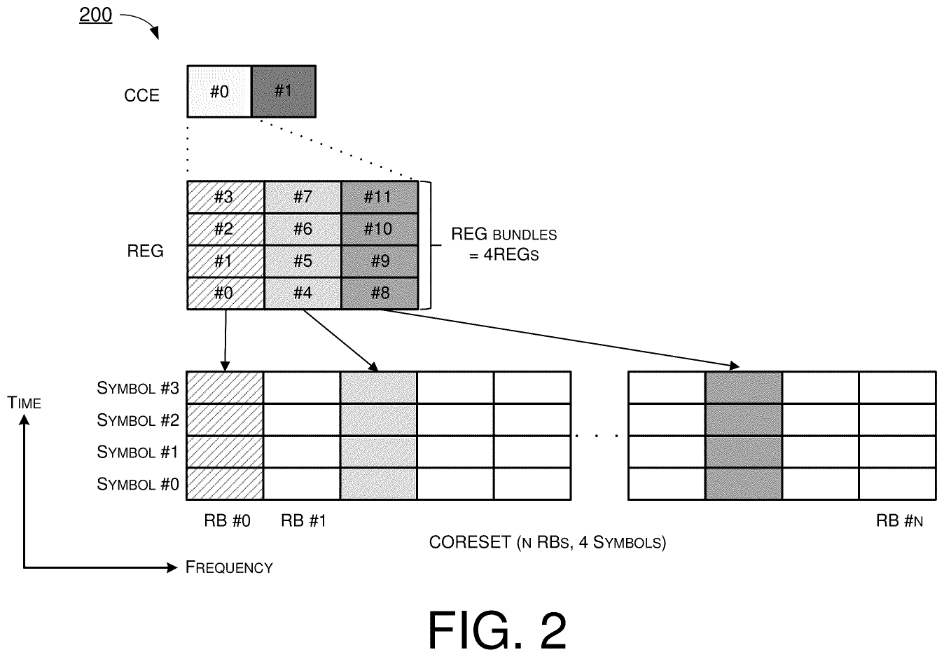

In one embodiment, for implementing interleaved CCE-REG-MappingType, the REG bundle size(s) should satisfy the following principles. Firstly, the REG bundle size(s) is larger than 1. Secondly, the REG bundle size(s) is an integer multiple of one of the candidate CORESET durations. Thirdly, the REG bundle size(s) is a divisor of the number of REGs making up a CCE, i.e., the number of REGs making up a CCE may be divided by the REG bundle size without a remainder. In one example, the maxCoReSetDuration may be set as 4 OFDM symbols. The candidate CORESET duration may be {1, 2, 3, 4}. One CCE may comprise 12 REG. One REG may comprise one RB in one OFDM symbol. The candidate REG bundle sizes may be 2, 3, 4, 6, or 12. In another example, the maxCoReSetDuration may be set as 4 OFDM symbols. The candidate CORESET duration may be {1, 2, 4}. One CCE may comprise 4 REGs. One REG may comprise one RB in one OFDM symbol. The candidate REG bundle sizes may include 2, or 4 REGs. In another example, the maxCoReSetDuration may be set as O OFDM symbols, where O may be larger than 6. In another example, the maxCoReSetDuration may be set as 6 OFDM symbols. The candidate CORESET duration may be {1, 2, 3, 6}. One CCE may comprise 6 REGs. One REG may comprise one RB in one OFDM symbol. The candidate REG bundle sizes may include 2, 3, or 6 REGs. FIG. 2 illustrates an exemplary diagram of the CORESET extension in the time domain in accordance with implementations of the present disclosure. As illustrated in FIG. 2, the maxCoReSetDuration is set as 4 OFDM symbols in the time domain. The CORESET duration is selected as 4 from {1, 2, 3, 4} for illustration. One CCE comprises 12 REGs. The REG bundle size is 4. Thus, the CCE comprises 3 REG bundles, which are interleaved and mapped into physical resources (i.e., physical resource blocks (PRBs)) in the time and frequency domain.

In one embodiment, for the CCE-REG-MappingType of non-interleaved, one method to increase the RE number M in the time domain is to enlarge the max CORESET duration (in the unit of one OFDM symbol), i.e., increasing the value of the RRC parameter of maxCoReSetDuration in the NR system. At the same time, the number of REGs making up a CCE may be a value no smaller than the maxCoReSetDuration. No REG bundle is needed for this case. In one example, the maxCoReSetDuration may be set as 4 OFDM symbols. The candidate CORESET duration may be {1, 2, 3, 4}. One CCE may comprise 6 REGs. One REG may comprise one RB in one OFDM symbol. For the case that the CORESET duration is set as 4, this value (4) may be bound to an aggregation level (AL) value that is larger than a threshold, e.g., three. In one example, the AL value bounded with the CORESET duration (4) is 8 or 16.

In one embodiment, for the case of increasing RE number M via CORESET extension in the frequency domain, a method of increasing the max size of a search space (e.g., increasing the max AL to a value larger than 16) is disclosed. In one example, the max AL may be set as 32, and all candidate ALs may include {1, 2, 4, 8, 16, 32}. The number of PDCCH candidate per AL within a search space may be configured from a set of {N0, . . . , Nn}, e.g., {0, 1, 2, 3, 4, 5, 6, 8}. The number of each PDCCH candidate per AL within a search space may be the same or different. In one example, for the candidate AL of {1, 2, 4, 8, 16}, the number of PDCCH candidate per these candidate AL within a search space may be configured from a set of {0, 1, 2, 3, 4, 5, 6, 8}. For the PDCCH candidate of AL 32, the number of it within a search space may be configured from a set with a maximum value smaller than 8, e.g., {0, 1, 2, 3, 4, 5, 6}. In one example, the max AL is configured per bandwidth part (BWP) or per sub-carrier spacing (SCS).

In the present disclosure, after the increment of the max AL of a search space, the CORESET may be within one BWP. In one embodiment, after the increment of the max AL of a search space, the CORESET may be across different BWPs and/or carriers. For this case, one embodiment is that an indication of the CORESET or PDCCH location with a small payload size may be transmitted in a BWP and/or carrier at a lower frequency. The indicated CORESET or PDCCH may be transmitted in one or multiple other BWP(s) and/or carrier(s) at a higher frequency. In this method, the PDCCH may be only mapped to the BWP and/or carrier at the higher frequency. In one embodiment, the PDCCH may be transmitted in both BWP and/or carrier at a lower frequency and the higher frequency. In this manner, the PDCCH may be mapped to both BWP and/or carrier at the lower and the higher frequency.

In one embodiment, a combination of increasing RE number M via CORESET extension in the time domain and frequency domain, as described above, may be utilized together and dynamically adapted. It means that the CORESET configuration may be dynamically adapted. In this embodiment, the CORESET configurations may at least include the CORESET duration in the time domain, the AL of the search space in the frequency domain, and the number of PDCCH candidates per each AL in the search space. The adaptation may be based on different targets for coverage, frequency band, service, and transmission type. The coverage target may be a value in the unit of meters, and/or a target signal-to-noise ratio (SNR) in the unit of dB. In one example, for at least one scenario of a coverage target larger than a threshold, a frequency band of frequency range 3 (FR3)/FR2, a transmission type of broadcast, and a service of NTN, the CORESET configuration may be adapted to at least one of a larger maxCoReSetDrtation of 4 and a larger AL of 32. Otherwise, the CORESET configuration may be adapted to a smaller maxCoReSetDrtation (e.g., 1, 2, and/or 3), and/or a smaller AL (e.g., 1, 2, 4, 8, and/or 16).

In the present disclosure, repetition may be implemented to improve the coverage of a wireless channel/signal (e.g., PDCCH). In one embodiment, the PDCCH repetition may be performed within one CORESET. In one embodiment, the PDCCH repetition may be performed every x CCE, where x is a divisor of AL. In one example, for an AL of 16, which means the PDCCH comprises 16 CCEs. In this case, x may be one of the values of {1, 2, 4, 8, 16}. In one example, for x=1, it means the PDCCH repetition may be performed every 1 CCE, i.e., it is repeatedly transmitted 16 times, and each repetition is on one CCE. For x=2, it means the PDCCH repetition is performed every 2 CCE, i.e., it is repeatedly transmitted 8 times, and each repetition is on two CCEs or occupies two CCEs. In another example, the PDCCH repetition may be performed every y monitoring occasion, where y may be a divisor of the total monitoring occasion number in a search space set. In one example, the search space set may comprise 16 monitoring occasions. In this case, y could be one of the values of {1, 2, 4, 8, 16}. In one example, for y=1, it means the PDCCH is repeatedly transmitted 16 times, and each repetition is on one monitoring occasion. For y=2, it means the PDCCH is repeatedly transmitted 8 times, and each repetition occupies one or two monitoring occasion(s).

In one embodiment, the PDCCH repetition may be performed across CORESET (i.e., CORESET repetition). Specifically, the PDCCH repetition may be performed across CORESET in the frequency domain and/or the time domain. For the case of PDCCH repetition across CORESETs (CORESET repetition in the frequency and/or the time domain), at least one of one or multiple new higher-layer parameter(s) and one or multiple new field(s) in the legacy higher-layer parameter(s) (e.g., ControlResourceSet) may be used for configuring repetition information. The repetition information may include one or multiple information including whether the repetition is enabled or not, and the repetition details including one or multiple information including repetition direction (e.g., repetition in frequency domain or time domain), repetition number, and the corresponding resource/location/occasion of repetitions. Specifically, one new field in the legacy higher-layer parameter ControlResourceSet may be added to indicate in an event that the repetition is enabled or disabled. In one example, the field name may be repetitionConfig. When this field (i.e., repetitionConfig) is absent, the UE may consider the repetition is disabled. When this field (i.e., repetitionConfig) is present, the UE may consider that the repetition is enabled. Further, for the field of repetitionConfig, some corresponding additional fields may be configured to indicate the repetition details. In one embodiment, two individual fields named frequencyDomainRepetition and timeDomainRepetition may be specified to indicate that the repetition is performed in the frequency domain or the time domain, respectively.

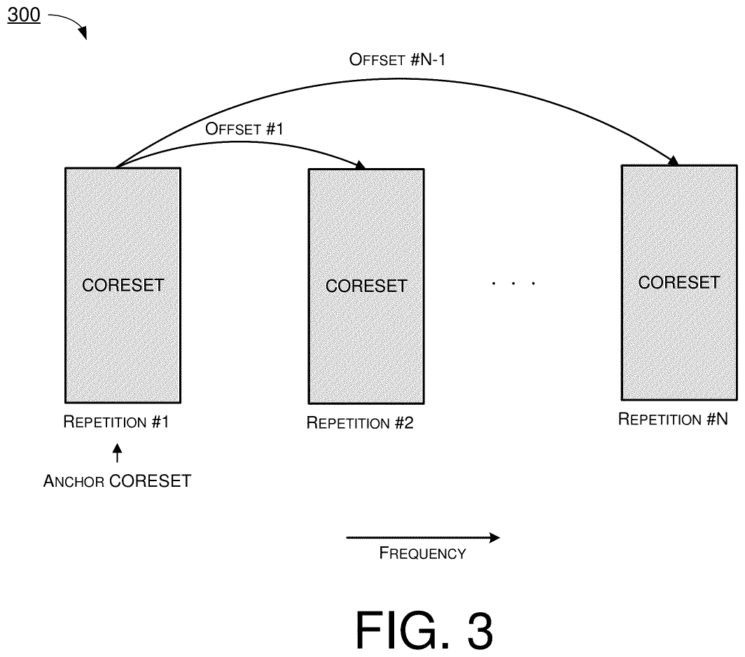

In one embodiment, for the field of frequecyDomainRepetition, some corresponding additional fields may be configured together to indicate repetition resource and repetition location in the frequency domain. FIG. 3 illustrates an exemplary diagram of N CORESET repetitions in the frequency domain in accordance with implementations of the present disclosure. In one embodiment, as illustrated in FIG. 3, the anchor CORESET may be configured via a set of RRC parameters, and the remaining N−1 CORESET repetitions may be configured via an offset compared to the anchor CORESET. In one example, a field of frequencyDomainResource in the form of a bitmap may be used to indicate the frequency resource/location of one repetition. In one example, N fields of frequencyDomainResource, in the form of a bitmap, may be configured for N repetitions in the frequency domain, with each field for one repetition. In one example, one field of frequencyDomainResource in the form of a bitmap may be configured to indicate the frequency location/resource of one CORESET (e.g., anchor CORESET). N−1 fields named OffsetofFrequencyDomain may be configured to indicate the frequency resource/location of the N−1 repetitions in the frequency domain by indicating the offset between the anchor CORESET and each of the N−1 repetitions in the frequency domain. In one example, the n^{th} OffsetofFrequencyDomain may be between the highest, the lowest, or central subcarrier, RE, RB, or CCE of the anchor CORESET and the lowest, the highest, or central subcarrier, RE, RB, or CCE of the n^{th} repetition, respectively, where n is an integer from the range of {2, 3, . . . , N−1}. Here, the anchor CORESET may be defined as the 1^{st} repetition. For this alternative, an example may be illustrated in FIG. 3.

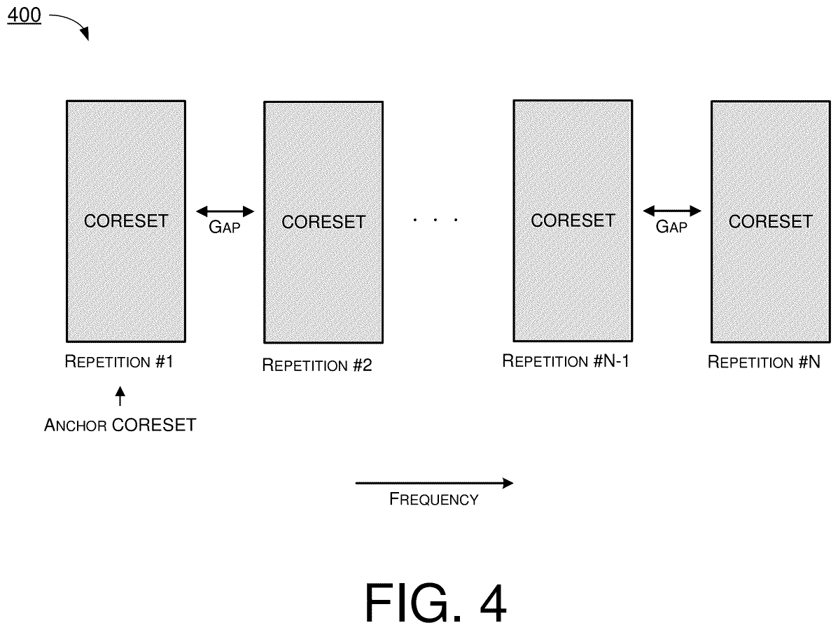

FIG. 4 illustrates an exemplary diagram of N CORESET repetitions in the frequency domain in accordance with implementations of the present disclosure. In one embodiment, as illustrated in FIG. 4, the anchor CORESET may be configured via a set of RRC parameters, and the remaining N−1 CORESET repetitions may be configured via one parameter of repetition time in the frequency domain, and a gap between two adjacent repetitions in the frequency domain. In one example, one field of frequencyDomainResource in the form of a bitmap may be configured to indicate the frequency location/resource of one CORESET (e.g., anchor CORESET). Additionally, one field (e.g., numOfFrequencyDomainRepetition) may be configured to indicate the number of CORESET repetitions in the frequency domain. One field (e.g., gapBetweenFrequencyDomainRepetition) may be configured to indicate the gap between two adjacent repetitions in the frequency domain. The gap may be between the lowest subcarrier, RE, RB, or CCE of the upper repetition and the highest subcarrier, RE, RB, or CCE of the lower repetition in the frequency domain, respectively. The anchor CORESET may be defined as the 1^{st} repetition. For this alternative, an example may be illustrated in FIG. 4.

For the field of timeDomainRepetition, some corresponding additional fields may be configured together to indicate the repetition resource/location/occasion of the search space in the time domain. In one embodiment, N field sets may be configured for N repetitions in the time domain, with each field set for one repetition. One manner of the field set (i.e., field-set-manner1) may include one or multiple of the fields of monitoringSlotPeriodicityAndOffset, duration, monitoringSymbolsWithinSlot, and nrofCandidates. In this manner, the field of monitoringSlotPeriodicityAndOffset may be used to configure the slots for PDCCH monitoring by configuring the periodicity and offset of the 1^{st} slot for PDCCH monitoring in units of slots. Different periodicity may be specified. For a periodicity of z slots, the corresponding offset may be within the range of {0, 1, . . . , z−1} slots. Different periodicities may be configured for different SCS. One principle is that for a smaller SCS, a set with smaller periodicity may be configured. Additionally, for different DCI formats/sizes, different periodicities may be configured. The field of duration may indicate the consecutive slots, starting from the 1^{st} slot, for PDCCH monitoring that the UE needs to monitor in every repetition occasion. The field of monitoringSymbolsWithinSlot in the form of the bitmap with a length of 14 indicates the 1^{st} symbol location within each monitored slot that the UE needs to monitor in every slot of every repetition occasion. The nrofCandidates may indicate the aggregation level and the number of this aggregation level included in the search space. It should be noted that for the N repetitions in the time domain, there may be N nrofCandidates fields, each for one repetition in the time domain. Alternatively, there may be only one nrofCandidates for N repetition in the time domain. In this manner, it means the N repetitions in the time domain share the same nrofCandidates.

Additionally, for the alternative N field sets, N repetitions may be configured in the time domain, with each field set for one repetition. Another manner of the field set (i.e., field-set-manner2) may include one or multiple of the fields of monitoringSymbolPeriodicityAndOffset, duration, and nrofCandidates. In this manner, the field of monitoringSymbolPeriodicityAndOffset may be used to configure the symbols for PDCCH monitoring by configuring the periodicity and offset of the 1st symbol for PDCCH monitoring in the unit of symbols. Different periodicity may be specified. For a periodicity of z symbols, the corresponding offset may be within the range of {0, 1, . . . , z−1} symbols. Different periodicity may be configured for different sub-carrier spacing (SCS). One principle is that for a smaller SCS, a set with smaller periodicity may be configured. Additionally, for different DCI formats/sizes, different periodicities may be configured. The field of duration indicates the consecutive symbols starting from the 1^{st} symbol for PDCCH monitoring that the UE needs to monitor in every repetition occasion. The nrofCandidates indicated the aggregation level and the number of this aggregation level included in the search space. It should be noted that there may be N nrofCandidates fields, each for one repetition in the time domain. Alternatively, there may be only one nrofCandidates for N repetition in the time domain. In this manner, it means the N repetitions in the time domain may share the same nrofCandidates.

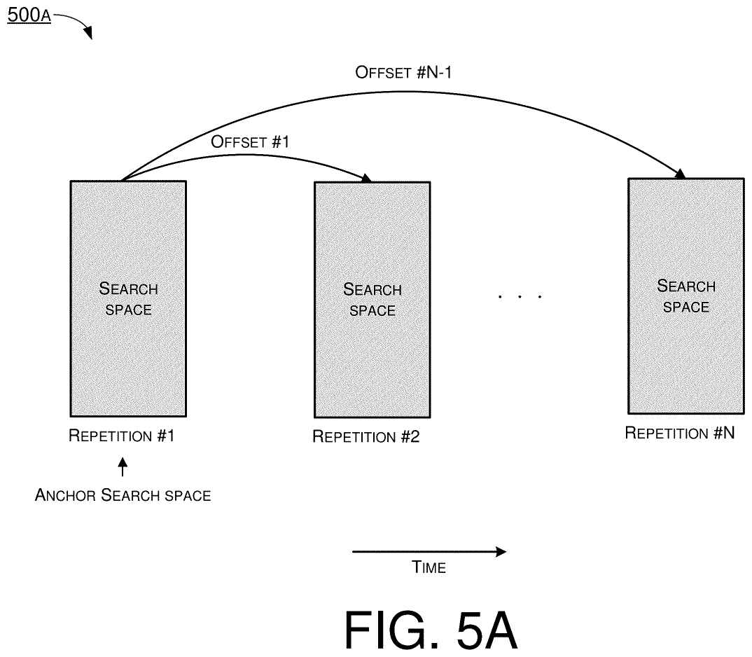

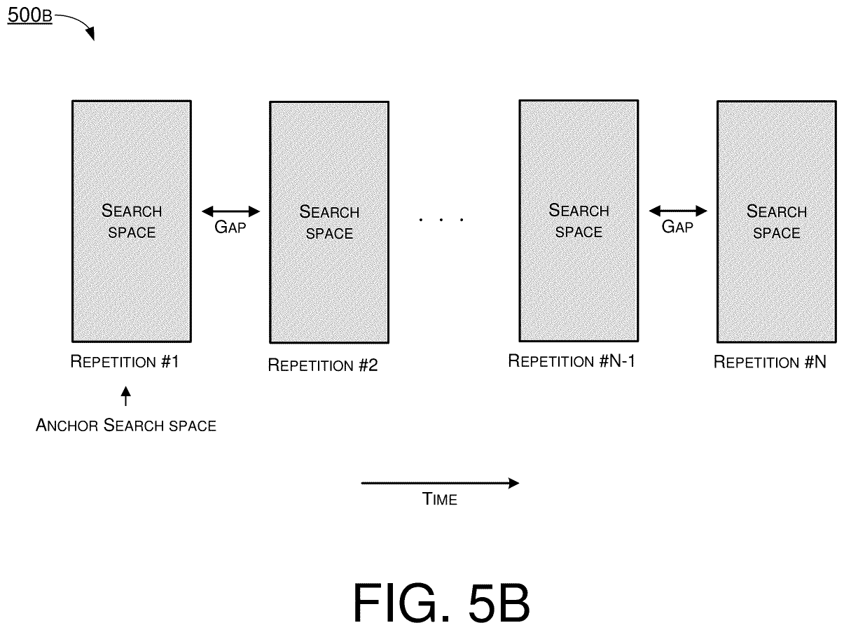

FIG. 5A illustrates an exemplary diagram of N search space repetitions in the time domain in accordance with implementations of the present disclosure. In one embodiment, as illustrated in FIG. 5A, the anchor search space may be configured via a set of RRC parameters, and the remaining N−1 search space repetitions may be configured via an offset compared to the anchor search space. In one embodiment, for the field of timeDomainRepetition, and some corresponding additional fields may be configured together to indicate the repetition resource/location/occasion in the time domain. In another embodiment, an alternative is that only one field set may be configured for one CORESET (e.g., anchor CORESET) or one search space set (e.g., anchor search space set). The field set may be either field-set-manner1 or field-set-manner2 described above. Additionally, N−1 fields of OffsetofTimeDomain may be configured for indicating the time resource/location of the N−1 repetitions in the time domain. In one example, the unit of OffsetofTimeDomain is a slot in an event that field-set-manner1 is used for the anchor CORESET or the anchor search space. In one example, the unit of OffsetofTimeDomain is symbol in an event that field-set-manner2 is used for the anchor CORESET or the anchor search space. The n^{th} OffsetofTimeDomain may be between the last slot (for field-set-manner1) or last symbol (for field-set-manner2) of the anchor CORESET and the 1^{st} slot (for field-set-manner1) or the 1^{st} symbol (for field-set-manner2) of the n^{th} repetition, whether n is an integer from the range of {2, 3, . . . , N−1}. In one example, the anchor COREST or the anchor search space may be defined as the 1^{st} repetition. For this alternative, an example is illustrated in FIG. 5A. Additionally, the unit of OffsetofTimeDomain may be milliseconds. For the case of OffsetofTimeDomain in the unit of slot and millisecond, one additional parameter for indicating the 1^{st} symbol index for PDCCH monitoring in the n^{th} repetition may be configured, where n is from the range of [2, N]. In another example, the index of 1^{st} symbol for PDCCH monitoring in the n^{th} repetition is the same as the index of the 1^{st} symbol for PDCCH monitoring in the anchor search space (i.e., the 1^{st} repetition) in an event that this additional parameter is absent, where n is from the range of [2, N].

FIG. 5B illustrates an exemplary diagram of N search space repetitions in the time domain in accordance with implementations of the present disclosure. In one embodiment, as illustrated in FIG. 5B, the anchor search space may be configured via a set of RRC parameters, and the remaining N−1 search space repetitions may be configured via one parameter of repetition time in the time domain, and a gap between two adjacent repetitions in the time domain. For the field of timeDomainRepetition, some corresponding additional fields may be configured together to indicate the repetition resource/location/occasion in the time domain. Another alternative is that only one field set may be configured for one CORESET (e.g., anchor CORESET) or one search space set (e.g., anchor search space set). The field set may be either field-set-manner1 or field-set-manner2 described above. Additionally, one field (e.g., numOfTimeDomainRepetition) may be configured to indicate the number of CORESET or search space repetition in the time domain. One field (e.g., gapBetweenTimeDomainRepetition) may be configured to indicate the gap between two adjacent repetitions in the time domain. The gap may be between the 1^{st} slot (for field-set-manner1) or 1^{st} symbol (for field-set-manner2) of the later repetition and the last slot (for field-set-manner1) or last symbol (for field-set-manner2) of the former repetition in the time domain, respectively. For this alternative, an example is illustrated in FIG. 5B. In one embodiment, if the field of numOfTimeDomainRepetition is absent, the repetition may be performed in the frame where the anchor search space (i.e., the 1^{st} repetition) occurs with a gap (configured by gapBetweenTimeDomainRepetition) between two adjacent repetitions.

In one embodiment, the two fields above, frequencyDomainRepetition and timeDomainRepetition, may be bound to the field repetitionConfig. It means that at least one of the fields frequencyDomainRepetition and timeDomainRepetition may be present only when the field of repetitionConfig is present. Otherwise, if the field of repetitionConfig is not present, neither the field of frequencyDomainRepetition nor the field of timeDomainRepetition is present. In another embodiment, the field of repetitionConfig may not be needed. Only two fields of frequencyDomainRepetition and timeDomainRepetition are configured. In this case, if repetition is enabled, at least one of the fields frequencyDomainRepetition and timeDomainRepetition is present; Otherwise, if repetition is disabled, neither field of frequencyDomainRepetition nor timeDomainRepetition is present.

In one embodiment, for the method of repetition in the frequency domain and time domain, the repetition pattern may be configured as a consecutive or non-consecutive pattern. The above-described methods of repetition in the frequency domain and time domain may be implemented for both consecutive and non-consecutive patterns. In one example, for a consecutive pattern, it may be achieved via setting the field of gapBetweenFrequencyDomainRepetition as 0 in an event that the repetition is in the frequency domain or setting the field of gapBetweenTimeDomainRepetition as 0 in an event that the repetition is in the time domain. In another example, there may be a new field for indicating whether the repetition pattern in the time domain or frequency domain is consecutive or non-consecutive. In this manner, if the repetition pattern in time or frequency is non-consecutive, the above-described method may be used. If t he repetition pattern is consecutive, only one field for indicating the location or resource of the anchor CORESET or the anchor search space in the frequency domain or time domain, and one field of numOfFrequencyDomainRepetition or numOfTimeDomainRepetition may be needed for the case of repetition in the frequency domain or time domain, respectively. Alternatively, if the repetition pattern is consecutive, only one field for indicating the location or resource of the anchor CORESET or search space in the frequency domain or time domain, one field for indicating the density of CORESET in a BWP for repetition in the frequency domain, and one field for indicating the density search space in a slot or a specific time duration for repetition in time domain.

In one embodiment, for the repetition in the time domain, a new field of enableTimeDomainRepetitioninDuration may be configured. There may be a field named duration to indicate the consecutive slot(s) or symbol(s) that the UE needs to monitor. If the enableTimeDomainRepetitioninDuration is present and/or set as enabled, it means repetition may be performed in the consecutive slot(s) or symbol(s) indicated by the field of duration. Otherwise, if the enableTimeDomainRepetitioninDuration is not present or present but set as disabled, it means repetition is not performed in the consecutive slot(s) or symbol(s) indicated by the field of duration.

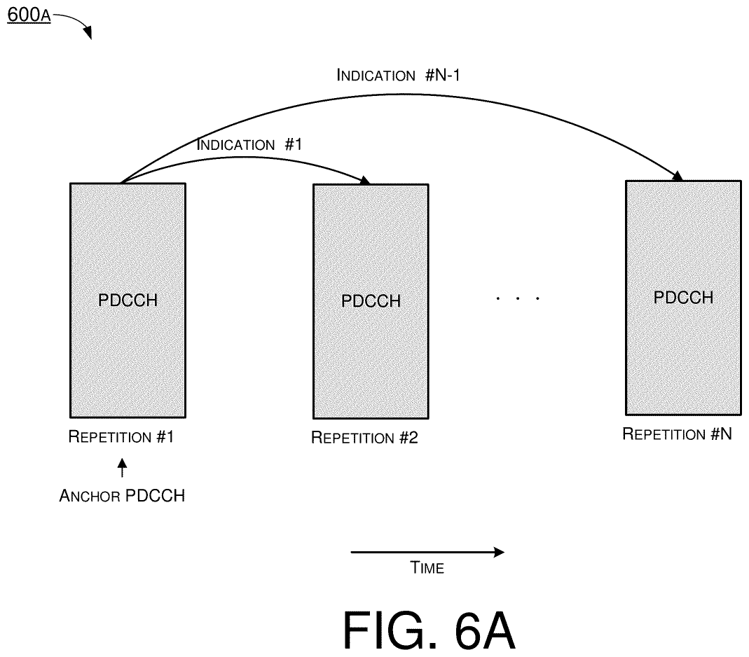

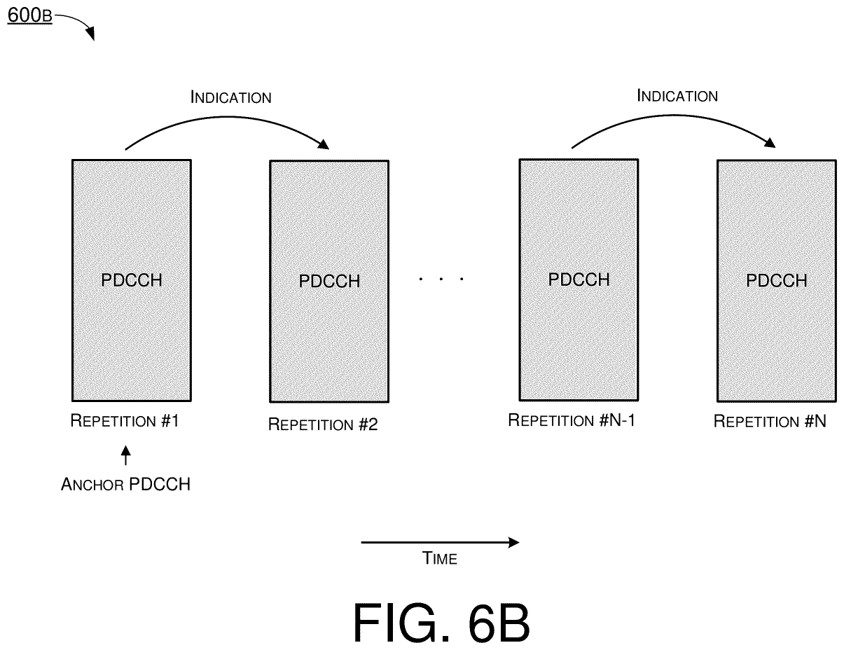

In one embodiment, for the repetition in the time domain, the repetition information may be dynamically indicated. The repetition info may include at least one of the following: whether repetition in the time domain is enabled, whether there is one or multiple repetitions on at least one of the following occasions, and the resource/occasion of the later one or multiple repetitions. The indication may be carried by PDCCH. In one embodiment, FIG. 6A illustrates an exemplary diagram of N PDCCH repetitions in the time domain in accordance with implementations of the present disclosure. As illustrated in FIG. 6A, the anchor PDCCH, i.e., 1st PDCCH, may be configured via a set of RRC parameters, and the remaining N−1 PDCCH repetitions may be indicated by the anchor PDCCH. In this embodiment, the resources/occasions of the N−1repetitions are indicated by the 1^{st} PDCCH. In another embodiment, FIG. 6B illustrates an exemplary diagram of N PDCCH repetitions in the time domain in accordance with implementations of the present disclosure. As illustrated in FIG. 6B, the anchor PDCCH, i.e., 1st PDCCH, may be configured via a set of RRC parameters, and the nth PDCCH repetitions may be indicated by the (n−1)^{th} PDCCH with n selected from the range of [2, N] (i.e., the resource/occasion of the n^{th} repetition is indicated by the (n−1)^{th} PDCCH, where n is in the range of {2, . . . , N}). In this case, if the indication of the repetition is present in a PDCCH, the UE may know the info of the repetition. Otherwise, if the indication of the repetition is absent in any PDCCH, the UE may not need to monitor the repetition. Additionally, regarding the resource/occasion of the latter one or multiple repetitions, it can be indicated via a time domain resource allocation (TDRA) manner. In this manner, one or multiple elements of the starting occasion (in the unit of slot and/or symbol) of the indicated repetition, and the length of the indicated repetition, may be included in the indication. In an alternative example, a table may be configured to specify the starting occasion (in the unit of slot and/or symbol) of the indicated repetition, and the length of the indicated repetition. In this case, the dynamic indication may include information of the row index of the table. In an alternative example, the indication may be carried by a different demodulation reference signal (DMRS) pattern/occasion. Several DMRS patterns may be pre-configured, each lined with one specific repetition info (e.g., the offset between the adjacent repetition, or the periodicity of the repetition). From the UE perspective, after obtaining the DMRS pattern, the UE may know the repetition, e.g., whether there is a repetition, and the location of the repetition.

In one embodiment, for the repetition across CORESET(s) or search space(s) in the frequency domain and the time domain, the PDCCH resources/locations within each CORESET or search space may be the same. In one example, the offset between the 1^{st} (available) PRB of CORESET and the 1^{st} PRB of PDCCH resources/locations may be the same across different repeated CORESETs. In one example, the offset between the 1^{st} (available) CCE of CORESET and the 1^{st} CCE of PDCCH resources/locations may be the same across different repeatedly CORESET. In one example, the 1^{st} slot or symbol for PDCCH monitoring in the time domain across different repeatedly search space may be the same. In this sense, from the UE perspective, after the blind detection in the anchor CORESET or the anchor search space, the UE may know the specific resource/location of the PDCCH in the anchor CORESET or the anchor search space. Based on it, the UE may assume the same resource/location of the PDCCH in the repeatedly CORESET or search space. In an alternative example, the PDCCH resources/locations within each CORESET or search space may be different. In this case, a parameter (e.g., offset) may be configured to indicate the location of the PDCCH resources/locations in the repeated CORESET or search space. The offset here may be the gap between two distances. For repetition in the frequency domain, the 1^{st} distance may be between the 1^{st} (available) PRB or CCE of the anchor CORESET and the 1^{st} PRB or CCE of PDCCH in the anchor CORESET. The 2^{nd} distance may be between the 1^{st} (available) PRB or CCE of repeated CORESET and the 1^{st} PRB or CCE of PDCCH in the repeated CORESET. For repetition in the time domain, the distance is between the 1^{st} (available) slot or symbol of the anchor search space and the 1^{st} slot or symbol of PDCCH in the anchor CORESET. Alternatively, the offset is the gap between the two indexes. For repetition in the frequency domain, the 1^{st} index may be the 1^{st} (available) PRB or CCE index of the anchor CORESET, and the 2^{nd} index may be the 1^{st} (available) PRB or CCE index of the repeated CORESET. For repetition in the time domain, the 1^{st} index may be the 1^{st} (available) slot or symbol index of the anchor search space, and the 2^{nd} index may be the 1^{st} (available) slot or symbol index of the repeatedly search space.

In one embodiment, the repetition info may be per-configured via a higher-layer parameter. In one example, whether the reconfigured repetition is activated or not may be determined via layer-one (L1) signaling. In one example, for both CORESET or search space repetition in the frequency domain and the time domain, the one or multiple of the repetition information including repetition direction, repetition resource/location/occasion may be preconfigured. After that, one or multiple L1 signaling may be transmitted to indicate whether one or multiple of the pre-configured repetitions are activated or not. In one example, the L1 signaling may be transmitted via a PDCCH.

In one embodiment, both pre-configuration via higher-layer parameters and dynamic indication via L1 signaling may be implemented together. In one example, the pre-configuration may configure different candidate possibilities of repetition info in the form of a table, and the L1 signaling may dynamically indicate the row index of the pre-configured table.

In one embodiment, a rule may be pre-defined. Based on this rule, the UE may determine or calculate the location of the repetition in the time and/or frequency domain. In one example, the anchor CORESET or the anchor search space set/PDCCH may be configured in a legacy manner. Based on the location of the anchor CORESET/search space set/PDCCH, the UE may determine or calculate the locations of the following (N−1) repetitions in the time domain and/or the frequency domain. The repetition location may be determined or calculated by the UE based on the 1^{st} CORESET location with at least one of the UE identity (ID), cell ID, resource location, and a specific value (e.g., total number of RBs or CCEs or total number of symbols) with a modular operation or an interleaving operation. In one example, the determination or the calculation may be based on a modular operation between the location of the anchor CORESET/search space set/PDCCH in the frequency domain (in the unit of RE or RB or CCE) or the time domain (in the unit of slot or symbol), and at least one of UE ID, cell ID, and a specific value. In one example, the specific value may be the total number of resources in the frequency domain, expressed in RE, RB, or CCE units. In one example, the specific value may be the total number of resources in the time domain, expressed as symbols, slots, sub-frames, or frames. In an alternative example, an interleaving operation may be used as the rule for the UE to determine the location of the following (N−1) repetition in the time domain and/or frequency domain.

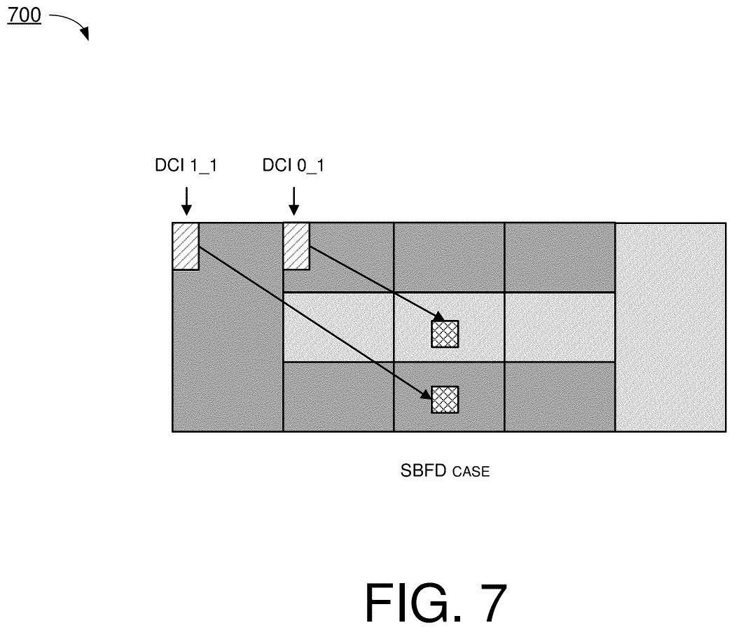

FIG. 7 illustrates an exemplary diagram of sub-band full duplex (SBFD) impacts on PDCCH repetitions in accordance with implementations of the present disclosure. In one embodiment, the available resource (e.g., RE, RB, or CCE number) may differ across OFDM symbols (e.g., SBFD symbols and non-SBFD symbols). In one embodiment, if the repetition in the time domain is considered, a solution is that the smallest AL among the OFDM symbols may be used for each repetition. In another embodiment, the largest AL among the OFDM symbols may be used for each repetition. For this alternative, if the symbol with an available resource (e.g., RE, RB, or CCE number) is smaller than the largest AL, a lower coding rate may be used. In another embodiment, a random AL among the OFDM symbols may be used for each repetition. For this alternative, for the symbol with an available resource (e.g., RE, RB, or CCE number) smaller than the random AL, a lower coding rate may be used. The random AL may be generated in the range from the min AL to the max AL. In another embodiment, the repetition may be only performed among the symbols with the same available resource (e.g., RE, RB, or CCE number, etc.) or the symbols defined as the same type (SBFD-symbol or non-SBFD symbol). For example, repetition may be performed only in either an SBFD symbol or a non-SBFD symbol.

### Illustrative Processes

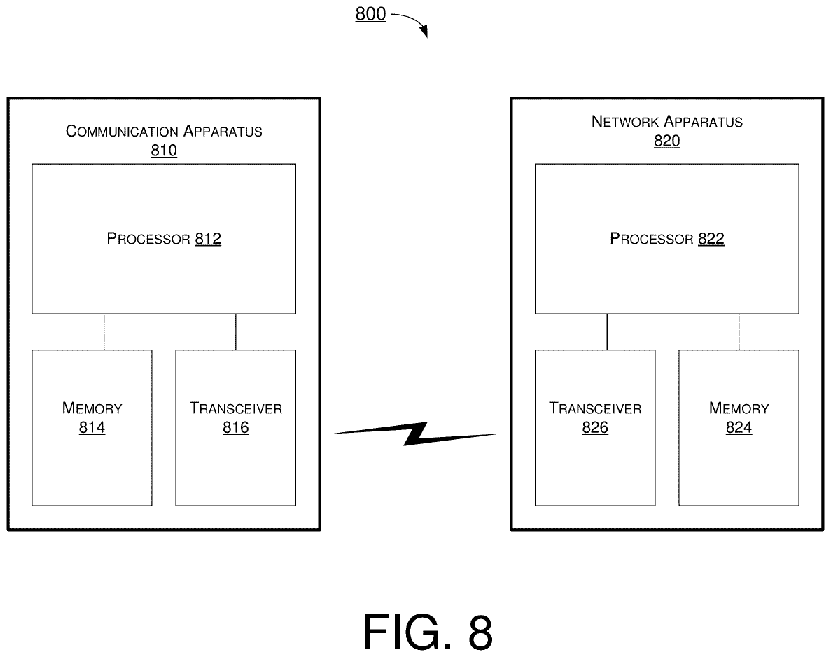

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes, and methods described herein pertaining to PDCCH coverage improvement with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer, or a notebook computer. Communication apparatus 810 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker, or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-IoT, or IIoT network, or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including PDCCH coverage improvement in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. Transceiver 816 may include an MR and an LR. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 620 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM), and/or phase-change memory.

### Illustrative Processes

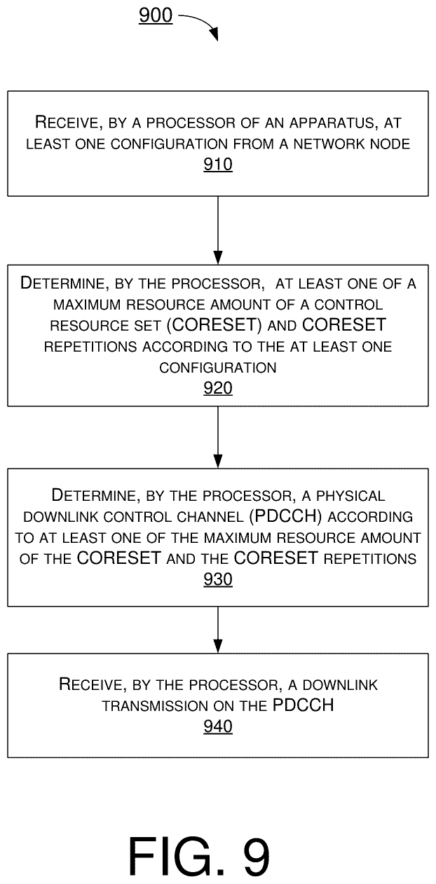

FIG. 9 illustrates an example process 900 in accordance with an implementation of the present disclosure. Process 900 may be an example implementation of above scenarios/schemes, whether partially or completely, with respect to PDCCH coverage improvement of the present disclosure. Process 900 may represent an aspect of implementation of features of communication apparatus 810. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810, any suitable UE, or machine-type devices. Solely for illustrative purposes and without limitation, process 900 is described below in the context of communication apparatus 810. Process 900 may begin at block 910.

At block 910, process 900 may involve processor 812 of communication apparatus 810 receiving, via transceiver 816, at least one configuration from a network node. Process 900 may proceed from block 910 to block 920.

At block 920, process 900 may involve processor 812 of communication apparatus 810 determining at least one of a maximum resource amount of a CORESET and CORESET repetitions according to the at least one configuration. Process 900 may proceed from block 920 to block 930.

At block 930, process 900 may involve processor 812 of communication apparatus 810 determining a physical downlink control channel (PDCCH) according to the at least one of the maximum resource amount of the CORESET and the CORESET repetitions. Process 900 may proceed from block 930 to block 940. Process 900 may proceed from block 930 to block 940.

At block 940, process 900 may involve processor 812 of communication apparatus 810 receiving, via transceiver 816, a downlink transmission on the PDCCCH.

In some implementations, the maximum resource amount of the CORESET may be determined by a maximum occupied symbol number of a CORESET duration configured in the at least one configuration.

In some implementations, the maximum occupied symbol number of the CORESET may be equal to or larger than 4.

In some implementations, the maximum resource amount of the CORESET may be determined by a parameter maxCoReSetDuration configured in the at least one configuration, and the parameter maxCoReSetDuration may be equal to or larger than 4.

In some implementations, the maximum resource amount of the CORESET may be determined by a maximum AL value of the CORESET configured in the at least one configuration, and the AL value of the CORESET may be greater than 16.

In some implementations, process 900 may involve processor 812 of communication apparatus 810 determining whether the CORESET repetitions are supported in a frequency domain or in a time domain according to the at least one configuration. The process 900 may also involve processor 812 of communication apparatus 810 performing the CORESET repetitions within a single CORESET according to the at least one configuration in an event that the at least one configuration indicates that the CORESET repetitions are supported in the frequency domain or in the time domain.

In some implementations, process 900 may involve processor 812 of communication apparatus 810 determining whether the CORESET repetitions are supported in a frequency domain or in a time domain according to the at least one configuration. The process 900 may also involve processor 812 of communication apparatus 810 performing the CORESET repetitions across CORESETs according to the at least one configuration in an event that the at least one configuration indicates that the CORESET repetitions are supported in the frequency domain or in the time domain.

In some implementations, the at least one configuration may further include N sets of configurations for the CORESET repetitions, where N is a repetition number of the CORESET repetitions. The process 900 may also involve processor 812 of communication apparatus 810 determining a first location and N−1 repetition locations of the CORESET repetitions according to the N sets of the configuration.

In some implementations, process 900 may involve processor 812 of communication apparatus 810 determining an anchor CORESET and a plurality of offsets for the CORESET repetitions according to the at least one configuration.

In some implementations, process 900 may involve processor 812 of communication apparatus 810 determining an anchor CORESET, a repetition number, and a periodicity for the CORESET repetitions or a gap between two adjacent CORESET repetitions according to the at least one configuration.

In some implementations, the CORESET repetitions may be performed only among SBFD symbols or non-SBFD symbols.

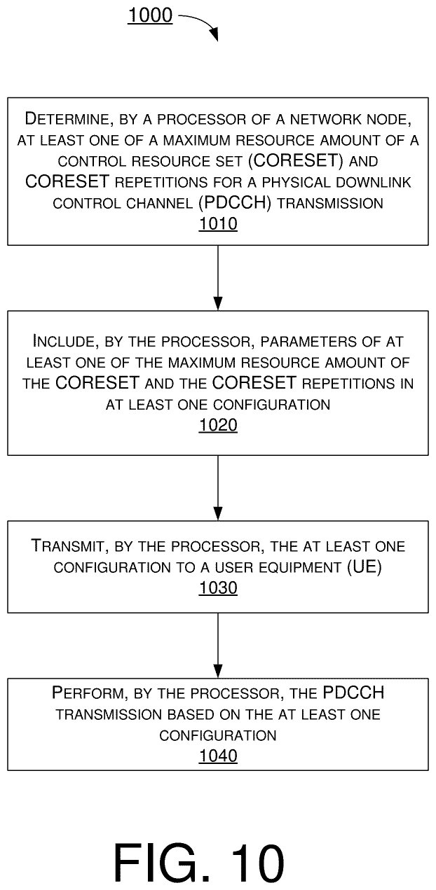

FIG. 10 illustrates an example process 1000 in accordance with an implementation of the present disclosure. Process 1000 may be an example implementation of above scenarios/schemes, whether partially or completely, with respect to PDCCH coverage improvement of the present disclosure. Process 1000 may represent an aspect of implementation of features of network apparatus 820. Process 1000 may include one or more operations, actions, or functions as illustrated by one or more of blocks 1010 to 1040. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network device or machine type devices. Solely for illustrative purposes and without limitation, process 1000 is described below in the context of network apparatus 820. Process 1000 may begin at block 1010.

At block 1010, process 1000 may involve processor 822 of network apparatus 820 determining at least one of a maximum resource amount of a CORESET and CORESET repetitions for a PDCCH transmission. Process 1000 may proceed from block 1010 to block 1020.

At block 1020, process 1000 may involve processor 822 of network apparatus 820 including parameters of at least one of the maximum resource amount of the CORESET and the CORESET repetitions in at least one configuration. Process 1000 may proceed from block 1020 to block 1030.

At block 1030, process 1000 may involve processor 822 of network apparatus 820 transmitting the at least one configuration to communication apparatus 810. Process 1000 may proceed from block 1030 to block 1040.

At block 1040, process 1000 may involve processor 822 of network apparatus 820 performing the PDCCH transmission based on the at least one configuration.

In some implementations, the maximum resource amount of the CORESET may be determined by a maximum occupied symbol number of a CORESET duration configured in the at least one configuration.

In some implementations, the maximum occupied symbol number of the CORESET may be equal to or larger than 4.

In some implementations, the maximum resource amount of the CORESET may be determined by a parameter maxCoReSetDuration configured in the at least one configuration. The parameter maxCoReSetDuration may be equal to or larger than 4.

In some implementations, the maximum resource amount of the CORESET may be determined by a maximum AL value of the CORESET configured in the at least one configuration. The AL value of the CORESET may be larger than 16.

In some implementations, the at least one configuration may further include N sets of configurations for the CORESET repetitions. The N may be a repetition number of the CORESET repetitions. The process 1000 may involve processor 822 of network apparatus 820 including a first location and N−1 repetition locations of the CORESET repetitions into the N sets of the configuration respectively.

In some implementations, process 1000 may involve processor 822 of network apparatus 820 including an anchor CORESET and a plurality of offsets for the CORESET repetitions.

In some implementations, process 1000 may involve processor 822 of network apparatus 820 including an anchor CORESET, a repetition number, and a periodicity for the CORESET repetitions or a gap between two adjacent CORESET repetitions.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, at least one configuration from a network node;
determining, by the processor, at least one of a maximum resource amount of a control resource set (CORESET) and CORESET repetitions according to the at least one configuration;
determining, by the processor, a physical downlink control channel (PDCCH) according to the at least one of the maximum resource amount of the CORESET and the CORESET repetitions; and
receiving, by the processor, a downlink transmission on the PDCCH.

2. The method of claim 1, wherein the maximum resource amount of the CORESET is determined by a maximum occupied symbol number of a CORESET duration configured in the at least one configuration.

3. The method of claim 2, wherein the maximum occupied symbol number of the CORESET is equal to or larger than 4.

4. The method of claim 1, wherein the maximum resource amount of the CORESET is determined by a parameter maxCoReSetDuration configured in the at least one configuration, and wherein the parameter maxCoReSetDuration is equal to or larger than 4.

5. The method of claim 1, wherein the maximum resource amount of the CORESET is determined by a maximum aggregation level (AL) value of the CORESET configured in the at least one configuration, and wherein the AL value of the CORESET is larger than 16.

6. The method of claim 1, further comprising:
determining, by the processor, whether the CORESET repetitions are supported in a frequency domain or in a time domain according to the at least one configuration; and
performing, by the processor, the CORESET repetitions within a single CORESET according to the at least one configuration in an event that the at least one configuration indicates that the CORESET repetitions are supported in the frequency domain or in the time domain.

7. The method of claim 1, further comprising:
determining, by the processor, whether the CORESET repetitions are supported in a frequency domain or in a time domain according to the at least one configuration; and
performing, by the processor, the CORESET repetitions across CORESETs according to the at least one configuration in an event that the at least one configuration indicates that the CORESET repetitions are supported in the frequency domain or in the time domain.

8. The method of claim 7, wherein the at least one configuration further comprises N sets of configurations for the CORESET repetitions, and N is a repetition number of the CORESET repetitions, and wherein the method further comprises:
determining, by the processor, a first location and N−1 repetition locations of the CORESET repetitions according to the N sets of the configuration.

9. The method of claim 7, further comprising:
determining, by the processor, an anchor CORESET and a plurality of offsets for the CORESET repetitions according to the at least one configuration.

10. The method of claim 7, further comprising:
determining, by the processor, an anchor CORESET, a repetition number, and a periodicity for the CORESET repetitions or a gap between two adjacent CORESET repetitions according to the at least one configuration.

11. The method of claim 7, wherein the CORESET repetitions is performed only among sub-band full duplex (SBFD) symbols or non-SBFD symbols.

12. A method, comprising:
determining, by a processor of a network node, at least one of a maximum resource amount of a control resource set (CORESET) and CORESET repetitions for a physical downlink control channel (PDCCH) transmission;
including, by the processor, parameters of the at least one of the maximum resource amount of the CORESET and the CORESET repetitions in at least one configuration;
transmitting, by the processor, the at least one configuration to a user equipment (UE); and
performing, by the processor, the PDCCH transmission based on the at least one configuration.

13. The method of claim 12, wherein the maximum resource amount of the CORESET is determined by a maximum occupied symbol number of a CORESET duration configured in the at least one configuration.

14. The method of claim 13, wherein the maximum occupied symbol number of the CORESET is equal to or larger than 4.

15. The method of claim 12, wherein the maximum resource amount of the CORESET is determined by a parameter maxCoReSetDuration configured in the at least one configuration, and wherein the parameter maxCoReSetDuration is equal to or larger than 4.

16. The method of claim 12, wherein the maximum resource amount of the CORESET is determined by a maximum aggregation level (AL) value of the CORESET configured in the at least one configuration, and wherein the AL value of the CORESET is larger than 16.

17. The method of claim 12, wherein the at least one configuration further comprises N sets of configurations for the CORESET repetitions, and N is a repetition number of the CORESET repetitions, and wherein the method further comprising:
including, by the processor, a first location and N−1 repetition locations of the CORESET repetitions into the N sets of the configuration respectively.

18. The method of claim 12, further comprising:
including, by the processor, an anchor CORESET and a plurality of offsets for the CORESET repetitions.

19. The method of claim 12, further comprising:
including, by the processor, an anchor CORESET, a repetition number, and a periodicity for the CORESET repetitions or a gap between two adjacent CORESET repetitions.

20. An apparatus, comprising:
a transceiver, during operation, wirelessly communicates with a wireless network; and
a processor communicatively coupled to the transceiver such that, during operation, the processor performs operations comprising:
receiving, via the transceiver, at least one configuration from a network node;
determining at least one of a maximum resource amount of a control resource set (CORESET) and CORESET repetitions according to the at least one configuration;
determining a physical downlink control channel (PDCCH) according to the at least one of the maximum resource amount of the CORESET and the CORESET repetitions; and
receiving, via the transceiver, a downlink transmission on the PDCCH.
